(19) United States
(12) Patent Application Publication
(10) Pub. No.: US 2016/0186983 A1
(43) Pub. Date: Jun. 30, 2016

(54) Mirror with Back Illumination

(71) Applicant: DUBIEL VITRIUM Spólka Jawna, Rabka Zdroj (PL)

(72) Inventor: Andrzej DUBIEL, Rabka Zdroj (PL)

(21) Appl. No.: 14/853,970

(22) Filed: Sep. 14, 2015

(30) Foreign Application Priority Data
Dec. 30, 2014 (PL) W.123421

(51) Int. Cl. F21V 33/00; A45D 42/10; F21S 8/00

(52) U.S. Cl. CPC F21V 33/004; F21S 8/033; A45D 42/10; F21Y 2101/02; F21Y 2103/003

(57) ABSTRACT

A mirror has a mirror plate with at least one strip of a light-conductive surface and a rear shield in the form of a thin-walled fitting made of plastics and tightly connected with the mirror plate on an external circumferentially closed sealing rim. In the shield there are profiled lighting channel cavities covering conductive surfaces alongside their edges. The cross section of lighting channel walls is shaped similarly to a flat right triangle, whose hypotenuse wall is a curve that is convex towards the outside of the mirror plate. A strip of LEDs is affixed to the wall perpendicular to the mirror plate. In the shield there are profiled hanging fixtures for a hooking component mounted on the wall of the room.

### CROSS-REFERENCE TO RELATED APPLICATION

This application claims the benefit of utility model application no. W.123421 filed with the Polish Patent Office on Sep. 30, 2014. The earliest priority filing date claimed is Sep. 30, 2014.

### FEDERALLY SPONSORED RESEARCH

Not Applicable

### SEQUENCE LISTING OR PROGRAM

Not Applicable

### BACKGROUND

The subject of the utility model is a mirror with back illumination emitted towards an onlooker through light-conductive surfaces without a reflective layer.

There are widely known solutions of mirrors with back illumination in which a mirror plate is equipped with light-conductive chemically or mechanically matted surfaces without a reflective layer. The area in front of the mirror is illuminated with the use of light sources, such as light-emitting diodes (LEDs), mounted on the back of the mirror. One of such solutions, shown in the German utility model No. DE202004000705U, has a rectangular mirror plate supported in a frame by a channel-shaped section, covering edges of the mirror plate with its arm ends. There is free space between frontal surfaces of mirror edges and section centre in which strips of light-emitting diodes (LEDs) are affixed to an inner surface of a web. Parallel to the edge of the mirror plate there are light-conductive surfaces without a reflective layer and illuminating the area in front of the mirror by means of LED light-beam introduced circumferentially in the direction parallel to a transparent surface of the mirror plate.

From Polish patent application for invention no. P-398408 there is also known a back-illuminated mirror with light-conductive surfaces. The mirror plate from behind has a tightly attached shield that covers the entire surface of the plate. The shield is a thin-walled plastic fitting, vacuum-thermoformed from a sheet. The peripheral edge of a rim is covered with a flexible and springy U-shaped seal. The seal is fastened with bolt connectors affixed to the mirror plate. Electric lighting system components are installed between the mirror plate and the shield.

In tender documentation of the Polish company DUBIEL Vitrum S.J. there is also known a mirror with back illumination equipped with a mirror plate with freely shaped light-conductive surface, illuminated from the back by strips of light-emitting diodes and tightly covered with a shield in the form of a thin-walled plastic fitting, vacuum-thermoformed from a sheet. The shield is equipped with at least one lighting channel covering the conductive surface along its edge. The shape of lighting channel cross section is similar to the letter “C”, whose side walls are ended with outwardly directed rims adjacent to the mirror plate. LED strips are affixed to internal surfaces of both side walls of the lighting channel.

In the described solutions, the area in front of the mirror is mostly illuminated with dispersed beaming, thus it requires accordingly increased electrical power consumption in order to achieve greater illumination intensity.

Similar to the above patent descriptions, the mirror according to the invention has a mirror plate with at least one strip of light-conductive surface without a reflective layer, and a rear wall in the form of a thin-walled fitting made of plastics. The shield is tightly connected with the mirror plate on the external circumferentially closed sealing rim. Moreover, the shield is equipped with profiled lighting channel cavities covering conductive surfaces along their edges. A strip of LEDs is affixed to the wall perpendicular to the mirror plate. The mirror is suspended on a room wall on hooking elements inserted into hanging fixtures profiled in the shield. The essence of the solution of this mirror according to the utility model lies in the fact that the shape of walls of the lighting channel in a cross section is similar to a flat right triangle, whose hypotenuse wall is a curve that is convex towards the outside of the mirror plate, especially a curve in the form of a quarter of an ellipsis.

The utility model is most beneficial when the shield is made using vacuum-thermoformed technology and is made of plastics with low light absorption, especially a white one.

The utility model mirror can be produced in two forms: demountable and non-demountable. In the demountable model, a shield is connected to a mirror plate with a flat seal located under a sealing rim and tightened by bolt connectors screwed into supports affixed to the mirror plate. In the non-demountable model, a shield is affixed with a sealing rim to the mirror plate.

In an alternate embodiment of the utility model, a shield is equipped with an external protective flange with its cross section shaped similarly to the letter “C”. Its one arm is affixed to the external edge of a sealing rim and it is not higher than the shield.

Another advantageous form of the mirror is a solution in which the shape of hanging fixtures is a two-stepped closed square cavity into which a load plate is affixed on a separation surface between those steps.

It is also beneficial when a mirror is equipped with a shield with three hanging fixtures arranged as vertices of a right triangle and a load plate has a shape of an angle with teeth located on its both internal sides.

### SUMMARY

A mirror with back illumination in accordance with the invention has a shield with lighting channels shaped in a way ensuring that beaming produced by LEDs is reflected towards an area in front of the mirror and resulting in a decreased amount of electrical power necessary in order to obtain the required illumination in this area. A simple technology of vacuum thermoforming of the thin-walled shield made of plastics allows for trouble-free mounting of an external protective flange onto the shield. The flange increases rigidity and the level of sealing in the connection between the shield with the mirror plate, and aesthetically covers the sealing area. The application of hanging fixtures makes the area under the cover tight where electrical elements are situated, as well as complete safety when using the mirror in humid rooms.

### DRAWINGS

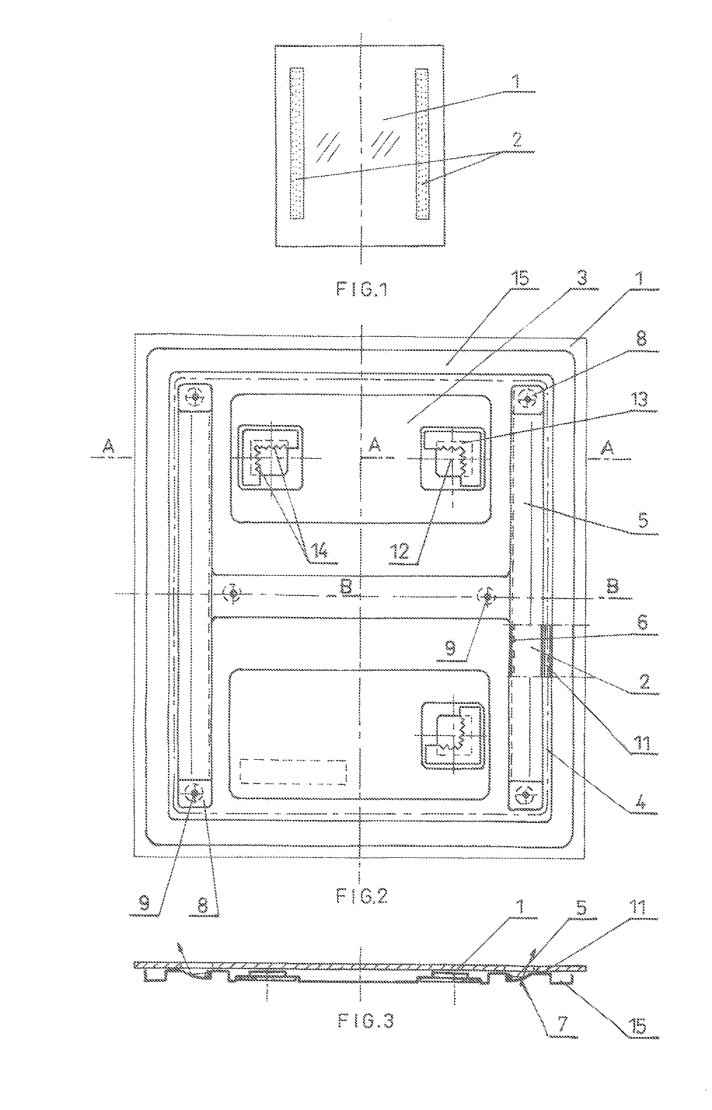

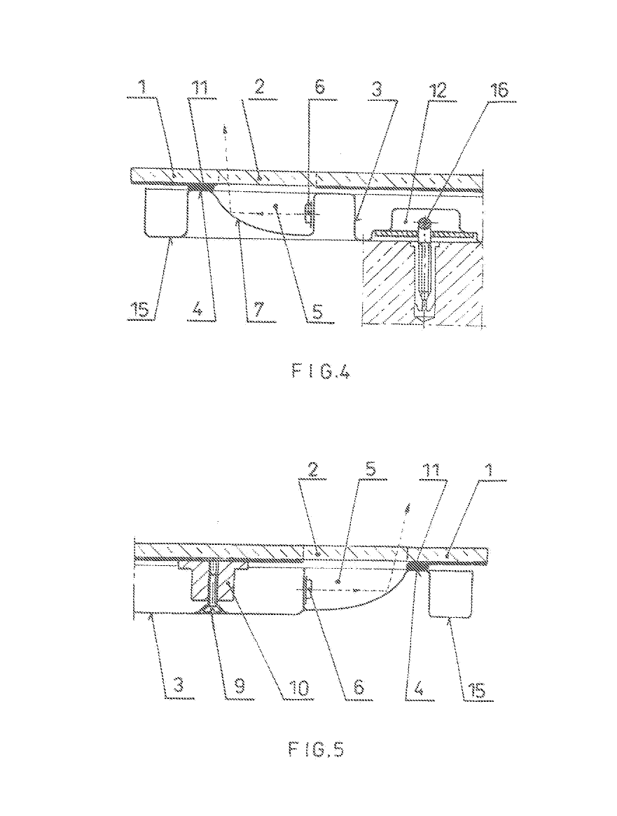

The structure of the mirror according to the utility model is shown in the picture as a solution with a rectangular mirror plate and two light-conductive surfaces situated alongside vertical sides of the mirror. Individual figures in the picture show the following elements: FIG. 1 shows a view in the front of the mirror, FIG. 2 shows a rear view of the mirror shield, FIG. 3 shows a cross section according to A-A line from FIG. 2, FIG. 4 shows magnification of A-A section in the range of half of mirror's width and FIG. 5 shows B-B section from FIG. 2.

### DETAILED DESCRIPTION

The rectangular mirror plate (1) shown in the picture has two vertical strips of a light-conductive surface (2) without a reflective layer and mechanically matted, e.g. by sandblasting. From the back, the mirror plate (1) is mounted with a shield (3) that has a shape of a thin-walled plastic fitting made of white thermoplastic plastics, performed in the vacuum thermoforming technology. The wall shield (3) on the external circumference is outwardly directed into a sealing rim (4) that contacts the mirror plate (1) through a flat seal (11). Depending on the form of the utility model, the mirror may be demountable, with the shield (3) tightened to the mirror plate (1) in tightening clamps (8) with bolt connectors (9) screwed into supports (10) affixed to the mirror plate (1), or non-demountable, with the shield (3) affixed to the mirror plate (1) with the sealing rim (4). Within the shield (3), there are profiled lighting channel cavities (5), covering conductive surfaces (2) alongside their edges. The shape of the channel walls (5) in cross section is similar to a flat right triangle, whose hypotenuse wall is a curve that is convex towards the outside of the mirror plate, especially the curve in the form of a quarter of an ellipsis. On the cathetus perpendicular to the mirror plate (1) there is an affixed strip of LEDs (6). In the shield (3) there are profiled hanging fixtures (12) for the hooking component (18) embedded in the wall of the room. Additional shield rigid element (3) and seal covering (11) are replaced with an external protective flange (15), whose cross section is shaped similarly to the letter “C”, with one arm connected with the external edge of the sealing rim (4) and not higher than the shield (3).

The shield (3) is equipped with hanging fixtures (12) profiled in the shape of a two-stepped closed square cavity. Hanging fixtures (12) are arranged as vertices of a right triangle, in which catheti are parallel to sides of the mirror plate (1). The loading plate (13) shaped in the form of an angle with teeth (14) on both internal sides is affixed on the separation surface between cavity steps. This solutions allows for hanging the mirror in a selected location in either vertical or horizontal direction of its longer side. The solution according to the utility model can applied in mirrors with any shape of a mirror plate (1) and conductive surfaces (2).

What is claimed:

1. A mirror with back illumination with a mirror plate (1) containing at least one strip of light-conductive surface (2) without a reflective layer and with a rear shield (3) in the form of a thin-walled fitting made of plastics, tightly connected to a mirror plate (1) on an external and circumferentially closed sealing rim (4); in the shield (3) there are profiled light channel cavities (5) covering conductive surfaces (2) alongside their edges and having a strip of LEDs (6) affixed to a wall perpendicular to the mirror plate (1); in the shield (2) there are profiled hanging fixtures (12) for a hooking component (18) mounted on the wall of the room and the mirror is characterised in that the cross section of lighting channel walls (5) is shaped similarly to a flat right triangle, whose hypotenuse wall (7) is a curve that is convex towards an outside of the mirror plate (1), especially a curve in the form of a quarter of an ellipsis.

2. The mirror according to claim 1 characterised in that its shield (3) is made using vacuum thermoforming technology and made of plastics of low light absorption, especially white.

3. The mirror according to claim 1 characterised in that its shield (3) is connected with a mirror plate (1) by a flat seal (11) under a sealing rim (4) and mounted by bolt connectors (9) screwed into supports (10) affixed to the mirror plate (1).

4. The mirror according to claim 1 characterised in that its shield (3) is affixed to a mirror plate (1) through a sealing rim (4).

5. The mirror according to claim 1 characterised in that its shield (3) has an external protective flange (15), with a cross section shaped as the letter “C”, with one arm connected with an external edge of a sealing rim (4) and which is not higher than the shield (3).

6. The mirror according to claim 1 characterised in that its hanging fixtures (12) are shaped as a two-stepped closed square cavity, into which a loading plate (13) is affixed on the separation surface between steps.

7. The mirror according to claim 6 characterised in that its shield (3) has three hanging fixtures (12) arranged as vertices of a right triangle and that a loading plate (13) has a shape of an angle with teeth (14) on both internal sides.
